(19) United States
(12) Patent Application Publication
(10) Pub. No.: US 2025/0355439 A1
(43) Pub. Date: Nov. 20, 2025

(54) SYSTEM AND METHOD FOR AUTOMATIC ASSET TRACKING

(71) Applicant: R-Go Robotics Ltd., Caesarea (IL)

(72) Inventor: Nizan HORESH, Caesarea (IL)

(73) Assignee: R-Go Robotics Ltd., Caesarea (IL)

(21) Appl. No.: 18/666,157

(22) Filed: May 16, 2024

(51) Int. Cl. G05D 1/249; G05D 1/667; G05D 105/28; G05D 107/70

(52) U.S. Cl. CPC G05D 1/249; G05D 1/667; G05D 2105/28; G05D 2107/70

(57) ABSTRACT

Techniques for asset tracking. A method includes identifying a starting point event based on an asset carrier interacting with an asset at a starting point location. An ending point event is identified. The ending point event is detected based on an ending point event activity of the asset carrier around an ending point location. The asset is identified with respect to the starting and ending point events. A path of the asset between the starting and ending point locations is determined based on locations occupied by the asset carrier between the starting point event and the ending point event. The path includes multiple locations of the asset at different times and the locations occupied by the asset carrier between the starting point event and the ending point event correspond to respective times. Locations of the assets at any of the different times may be determined based on the path.

### TECHNICAL FIELD

The present disclosure relates generally to asset tracking, and more specifically to asset tracking techniques which reduce the amount of computation performed in order to identify locations of an asset at different points in time.

### BACKGROUND

Various organizations use asset tracking techniques in order to keep track of objects or other assets as they move. This need is particularly relevant for organizations which handle a large number of assets on a daily basis. For example, companies which utilize large warehouses to store and ship packages ordered by customers may keep track of thousands or millions of objects at a time. Many of these packages may include very small objects, which are individually tracked. For example, a facility shipping toys may include very small toys such as small plastic figures or replacement parts of larger toys, and individually tracking many small items may increase the amount of computational work needed to perform tracking. Tracking the locations of the assets to be shipped as packages therefore helps the organization to efficiently pack and ship those packages.

Tracking packages can present particular challenges when assets move within a facility. For example, some organizations allow workers in warehouses to move assets as needed, and do not necessarily require that assets are stored in pre-designated areas (e.g., storing cereal boxes in a pre-designated cereal box area). That is, some advanced warehouses, such as some warehouses run by large online retailers, allow objects to move and be stored flexibly in different locations. This may be done, for example, in order to improve efficiency of storage, for example by allowing an asset to be deposited at the nearest storage location rather than requiring the asset to be moved to a predesignated location which may be farther away. Although this policy may improve efficiency of asset movement, tracking assets subject to this kind of policy becomes increasingly challenging.

Tracking assets throughout a facility may be useful for purposes such as identifying locations of specific assets or specific types of assets at a given point in time, identifying a nearest asset to a given asset carrier (e.g., a robot or vehicle such as a forklift) or employee of the facility, and the like. For example, when 3 different types of assets are needed to assemble a particular package by an employee of the facility where each type of asset can be stored in different locations (not a single predesignated location), it may be useful to identify the nearest asset of each of the 3 types to a current location of the employee, or identify an optimal order for the employee to pick up the assets.

Moreover, tracking of assets may be particularly important when the assets are or include materials which are not allowed to cross-contaminate. For example, vials in a pharmaceutical manufacturing facility may not allow to cross paths in order to ensure that medicines are not cross-contaminated. In these kinds of use cases, tracking locations of assets with higher granularity may be particularly relevant.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for asset tracking. The method comprises: identifying a first event, wherein the first event occurs when an asset carrier interacts with an asset at a first location; identifying a second event, wherein the second event is detected based on an activity of the asset carrier with respect to a second location; identifying the asset with respect to each of the first event and the second event; determining a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and determining a location of the asset at a first time of the plurality of times based on the path.

Certain embodiments disclosed herein also include a non-transitory computer readable medium having stored thereon causing a processing circuitry to execute a process, the process comprising: identifying a first event, wherein the first event occurs when an asset carrier interacts with an asset at a first location; identifying a second event, wherein the second event is detected based on an activity of the asset carrier with respect to a second location; identifying the asset with respect to each of the first event and the second event; determining a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and determining a location of the asset at a first time of the plurality of times based on the path.

Certain embodiments disclosed herein also include a system for asset tracking. The system comprises: a processing circuitry; and a memory, the memory containing instructions that, when executed by the processing circuitry, configure the system to: identify a first event, wherein the first event occurs when an asset carrier interacts with an asset at a first location; identify a second event, wherein the second event is detected based on an activity of the asset carrier with respect to a second location; identify the asset with respect to each of the first event and the second event; determining a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and determine a location of the asset at a first time of the plurality of times based on the path.

Certain embodiments disclosed herein include the method, non-transitory computer readable medium, or system noted above, further including or being configured to perform the following step or steps: performing an action with respect to the asset based on the determined location.

Certain embodiments disclosed herein include the method, non-transitory computer readable medium, or system noted above, further including or being configured to perform the following step or steps: determining a position of the asset with respect to the asset carrier for the plurality of times, wherein the plurality of locations of the asset are determined based on the plurality of locations occupied by the asset carrier and the position of the asset with respect to the asset carrier.

Certain embodiments disclosed herein include the method, non-transitory computer readable medium, or system noted above, further including or being configured to perform the following step or steps: determining a position of the asset with respect to a component of the asset carrier, wherein the position of the asset with respect to the asset carrier is determined based further on the position of the asset with respect to the component.

Certain embodiments disclosed herein include the method, non-transitory computer readable medium, or system noted above, wherein the starting point event is identified based on visual content showing the asset carrier interacting with the asset.

Certain embodiments disclosed herein include the method, non-transitory computer readable medium, or system noted above, wherein the visual content is captured by a camera at a camera location, further including or being configured to perform the following step or steps: determining the first location based on the camera location and the visual content showing the asset carrier interacting with the asset.

Certain embodiments disclosed herein include the method, non-transitory computer readable medium, or system noted above, wherein the second event is detected when at least a portion of the asset carrier is scanned at the second location.

Certain embodiments disclosed herein include the method, non-transitory computer readable medium, or system noted above, wherein the first event is a pickup of the asset.

Certain embodiments disclosed herein include the method, non-transitory computer readable medium, or system noted above, wherein the first event is a drop off of the asset.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram utilized to describe activities of an asset tracking system according to an embodiment.

FIG. 3 is an example diagram of asset carrier movement utilized to describe various disclosed embodiments.

FIG. 4 is a flowchart illustrating a method for automatic asset tracking according to an embodiment.

FIG. 5 is a flowchart illustrating a method for analyzing vehicle localization data according to an embodiment.

FIG. 6 is a flowchart illustrating a method for identifying asset crossover events utilizing automatic asset tracking according to an embodiment.

FIG. 7 is a schematic diagram of a tracking manager according to an embodiment.

### DETAILED DESCRIPTION

The embodiments disclosed herein include techniques for automatic asset tracking. Various disclosed embodiments may allow for locating or otherwise determining the path of an asset. More specifically, the disclosed embodiments allow for efficiently tracking locations of asset while minimizing consumption of computing resources needed to determine locations of each asset at different points in time.

In an embodiment, a starting point event in which an asset carrier such as a vehicle interacts with an asset such as an object is identified. Such a starting point event may be, for example, a pickup or drop off event. A location of the asset at the time of the starting point event is determined, for example, based on a known location of the asset carrier at such time. An ending point event indicative of one or more predetermined ending point event actions of the asset carrier is detected. The ending point event is detectable based on movement of the asset carrier with respect to an ending point location and may be, but is not limited to, passing a checkpoint or gate (e.g., as detected by scanning a barcode of the asset carrier as it passes through the checkpoint or gate), occupying a certain location, performing an action to release the asset (e.g., lowering forks of a forklift on which the asset is disposed), and the like. A location of the asset at the time of the ending point event is determined, for example, based on a location of an endpoint (e.g., a checkpoint or gate) or based on a known location of the asset carrier.

Once a starting point event and an ending point event have been identified, a path of the asset between the starting point event and the ending point is determined based on locations of the asset carrier at times between the starting point event and the ending point event. To this end, the asset may be localized relative to the asset carrier, and such localization may be utilized to determine positions of the asset at various points in time based on the positions of the asset carrier at each of those points in time.

Moreover, in at least some embodiments, the path, a specific location of the asset along that path, or both, may be calculated on demand. That is, in such embodiments, the necessary computations for localizing the asset relative to the asset carrier in order to determine a location of the asset at a given point in time may be performed only as needed. By only localizing the asset relative to the asset carrier as needed, the amount of additional data needed to store various locations and positions of the asset, as well as the computational power needed to calculate each of those locations and positions, can be reduced.

In this regard, it has been identified that asset tracking can be improved by utilizing the locations and paths of asset carriers which transport assets. By limiting the amount of data needed to track an asset (i.e., as compared to continuously tracking an asset's locality) and by limiting the type of data needed to track an asset (e.g., visual sensors, location sensors on assets, etc.), less computational resources are needed to determine where an asset is and a path it has taken. In particular, processing power and memory used to store and process such continuous tracking data may be reduced, as well as any networking resources used to transmit such data from sensors to tracking systems.

To analyze the asset carrier localization data to identify a path, cameras, a computer, or some inertial sensors may be utilized. In some instances, an odometry reading from wheels of the asset carrier can be utilized. The coordinates of the asset to the coordinates of the asset carrier can be converted to estimate the position of the asset relative to the asset carrier. Furthermore, the location of the asset can be determined in three dimensions based on the elevation of an asset-handling attachment of the asset carrier. As a non-limiting example, when an asset is placed on a shelf using a forklift, the storage height of the asset can be determined based on the height of the forks of the forklift at the time of release of the asset (e.g., using an encoder of a fork elevation system, using visual detection, etc.).

It has further been identified that tracking assets as discussed herein without requiring tracking the location of each asset at all times may be further used to improve reconstruction of asset whereabouts retroactively. That is, when an incident happens which calls for reconstructing the locations of certain assets as they moved throughout a facility, the disclosed embodiments may be used for such reconstruction while minimizing the amount of computing resources needed to be utilized. More specifically, since various disclosed embodiments do not require effectively storing the location of each asset at all times, the disclosed embodiments may reduce the amount of data which needs to be stored in order to enable such a reconstruction later. Moreover, the amount of computational processing needed to determine locations of assets based on stored video data or other data from which asset locations can be calculated may be reduced using various disclosed embodiments.

In this regard, it is noted that certain implementations may require identifying when assets entered or exited certain parts of the facility, when assets crossed paths, and the like. For example, as noted above, pharmaceutical manufacturing facilities or other facilities which handle medical ingredients, certain types of medications, or medical devices, may need to avoid certain types of assets coming into contact or crossing paths in order to prevent cross-contamination. Likewise, facilities that handle certain types of foods or ingredients of foods may wish to avoid cross-contaminating certain foods (e.g., avoiding cross-contamination between foods processed with meat and foods processed without meat). If a potential cross-contamination event has occurred, reconstructing locations of specific assets at specific times may allow for either verifying that no cross-contamination occurred or identifying which assets may have been affected. The disclosed embodiments may allow for performing such verification or identification more efficiently as compared to existing solutions.

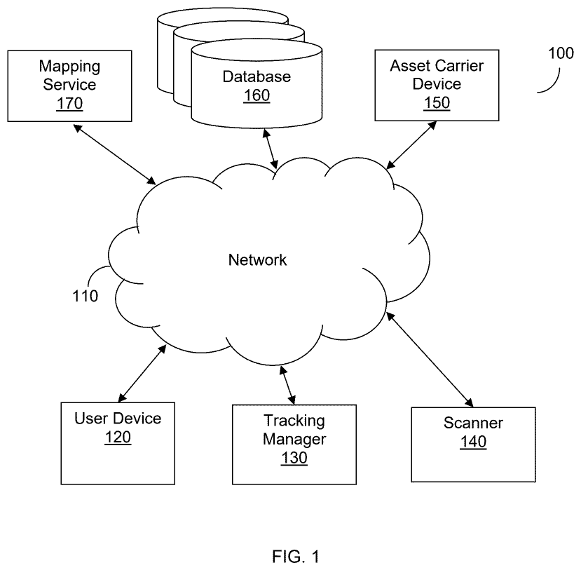

FIG. 1 shows an example network diagram 100 utilized to describe the various disclosed embodiments. In the example network diagram 100, a user device 120, a tracking manager 130, a scanner 140, an asset carrier device 150, one or more databases 160, and a mapping service 170 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving and displaying notifications. The user device 120 may be configured, for example, to receive and display notifications sent by the tracking manager 130 (e.g., notifications indicating determined paths of assets, notifications indicating information about asset crossover events, etc.).

The tracking manager 130 is configured to track assets (not shown in FIG. 1) with respect to locations (for example, locations within a facility, also not shown in FIG. 1) in accordance with various disclosed embodiments. More specifically, the tracking manager 130 is configured to determine paths of assets based on identified starting and ending point events based on locations of those events as well as locations of an asset carrier which transported the asset between the starting and ending point events. Accordingly, the tracking manager 130 is configured to effectively reconstruct the locations of assets based on the asset carriers which interacted with the assets.

To facilitate various disclosed embodiments and to further improve granularity of tracking activities, the tracking manager 130 may be further configured to determine asset locations relative to asset carriers or components of asset carriers. These relative locations, which may be defined in three-dimensional space, may be utilized to more granularly identify the locations of assets using the locations of the asset carriers carrying those assets at certain points in time.

Moreover, the tracking manager 130 may be configured to utilize the determined paths in order to identify asset crossover events. That is, the tracking manager 130 may be configured to reconstruct paths of assets which may have been involved in potential crossover events in order to determine whether those assets crossed paths as well as circumstances of the crossover events such as, but not limited to, locations and times of crossover events.

The scanner 140 is deployed in a facility in which the assets to be tracked are transported, and is configured to capture data (e.g., via one or more sensors, not shown) which may be utilized by the tracking manager 130 to determine paths of assets as discussed herein. Such data may include, but is not limited to, visual data (e.g., video or images) showing assets being transported, data based on reflections of light (e.g., LIDAR data or other laser-based data, or other data captured based on projection and detection of light), both, and the like. Such data from the scanner 140 may be stored, for example in one or more of the databases 160, for subsequent use by the tracking manager 130.

The asset carrier device 150 may be deployed in or with an associated asset carrier (not depicted in FIG. 1) deployed in the facility in order to transport one or more assets. In accordance with various disclosed embodiments, locations of the asset carrier may be tracked and stored by the asset carrier device 150, for example in one or more of the databases 160, for subsequent use by the tracking manager 130. To facilitate tracking the locations of the asset carrier 150, the asset carrier device 150 may be configured to provide location-relevant data such as, but not limited to, global positioning system (GPS) data or other data indicative of an absolute or relative location of the asset carrier associated with the asset carrier device 150, for use by the tracking manager 130 in identifying locations of the asset carrier associated with the asset carrier device 150 at various points in time while the asset carrier is transporting assets.

As discussed below, in some implementations, the asset carrier device 150 may communicate data such as an identifier of the associated asset carrier and location data indicating locations of the associated asset carrier at different points in time to the mapping service 170, which may facilitate collection and organization of asset carrier identification and location data to be provided to the tracking manager 130.

The asset carrier associated with the asset carrier device 150 may be, but is not limited to, a forklift, a vehicle such as a truck, a motorized cart, a bipedal robot or other robot, a drone, or any other system adapted for locomotion which may be utilized to carry or otherwise transport assets.

The databases 160 may store data to be used by the tracking manager 130 for determining paths of assets such as, but not limited to, data captured by the scanner 140, by the asset carrier 150, or both. The databases 160 may further be utilized to store data resulting from processes performed by the tracking manager such as, but not limited to, determined paths of assets, circumstances of identified asset crossover events, and the like.

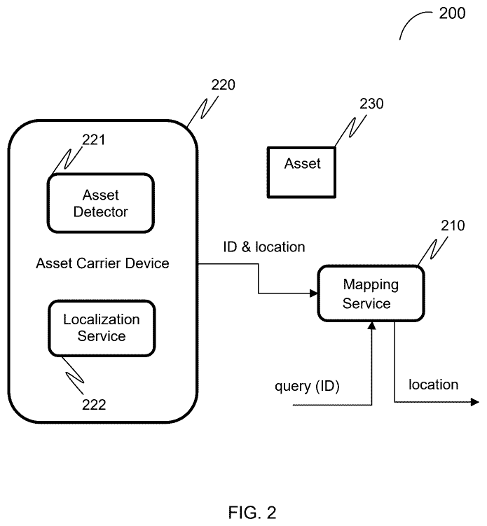

In some implementations, collection of data from asset carriers such as the asset carrier associated with the asset carrier device 150 may be facilitated by a mapping service 170. As discussed below with respect to FIG. 2, the mapping service may facilitate distribution of data from one or more asset carriers such as, but not limited to, the asset carrier associated with the asset carrier device 150. Specifically, data such as identifiers and location data may be collected from asset carriers, and provided to the tracking manager 130 as needed in order to determine paths between start and end points for purposes of reconstructing asset locations over time.

It should be noted that only a single scanner 140 and asset carrier 150 are depicted in FIG. 1 for simplicity purposes, but that the disclosed embodiments are not limited as such. Multiple scanners, asset carriers, or both, may be utilized without departing from the scope of the disclosure. In particular, in at least some situations, data from multiple scanners, multiple asset carriers, or both, may be utilized in order to further reconstruct locations of an asset as it moves throughout a facility (e.g., between areas of the facility covered by different scanners, or as the asset is transferred from one asset carrier to another).

FIG. 2 is a flow diagram 200 utilized to describe activities of an asset tracking system according to an embodiment. As depicted in FIG. 2, a mapping service 210 communicates with an asset carrier device 220. The mapping service 210 may be realized via instructions, for example, instructions stored and executed by the tracking manager 130, FIG. 1. The asset carrier device 220 may be deployed on or with an asset carrier such as, but not limited to, the asset carrier 150, FIG. 1. As discussed above, the asset carrier may transport an asset such as, but not limited to, the asset 230.

As depicted in FIG. 2, the mapping service 210 communicates with the asset carrier device 220 in order to receive data such as, but not limited to, an identifier (ID) and location data for the asset carrier of the asset carrier device 220. More specifically, the mapping service 210 may obtain such data from the asset carrier device 220 periodically or otherwise regularly, may obtain such data on an as-needed basis (e.g., based on requests from a tracking manager such as the tracking manager 130, FIG. 1), or both. To this end, the mapping service 210 may receive a query indicating an ID of the asset carrier for which location data is desired, and may output location data for that asset carrier. The mapping service 210 may store such identifiers and corresponding location data for the asset carriers associated with those identifiers locally (i.e., in a system executing instructions used to realize the mapping service 210), or in a separate storage (e.g., one or more of the databases 160, FIG. 1).

As depicted in FIG. 2, the asset carrier device 220 includes an asset detector 221 and a localization service 222. Each of the asset detector 221 and the localization service 222 may be realized as hardware components or as software components (e.g., realized as one or more sets of instructions executed by the asset carrier device 220). The asset detector 221 may be configured to detect interactions with the asset 230 such as, but not limited to, picking up the asset 230 (pickup event), dropping off the asset 230 (drop off event), and the like. The localization service 222 is configured to determine a location of the asset carrier device 220, which may be performed using one or more localization techniques. Such locations may be utilized to determine the location of the associated asset carrier at different points in time, which in turn may be utilized to determine locations of the asset 230 in accordance with various disclosed embodiments.

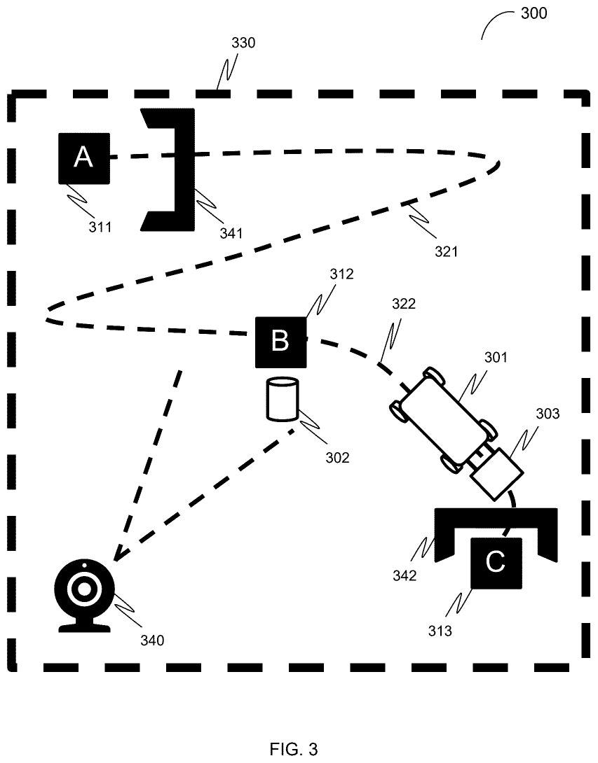

FIG. 3 is an example diagram 300 illustrating asset carrier movement utilized to describe various disclosed embodiments. As depicted in FIG. 3, an asset carrier 301 in the form of a forklift is capable of locomotion via a set of wheels moves within an environment 330. Specifically, FIG. 3 illustrates the asset carrier 301 moving from point A 311 to point B 312 and then to point C 313 within the environment 330. The path followed by the asset carrier 301 includes a first portion 321 between the points A 311 and B 312, and a second portion 322 between the points B 312 and C 313.

In an example instance, the asset carrier 301 picks up a first asset 302 at the point A 311 and carries or otherwise moves the asset 302 to the point B 312, where the asset carrier 301 drops off the first asset 302. As the asset carrier 301 moves away from the point A 311 after picking up the asset 302, the asset carrier 301 passes through a gate 341 where the asset 302 is scanned. At point B 312, the asset is dropped off.

In this regard, during the first portion of this instance in which the first asset 302 is moved from point A 311 to point B 312, point B 312 acts as a starting point location of a starting point event in the form of a drop off event which triggers identification of a starting point event, and the location of the gate 341 acts as an ending point location of an ending point event in the form of a scan at the gate 341. The ending point location therefore indicates a termination point before which it cannot be assumed that the location of the asset 302 corresponds to the location of the asset carrier 301 (i.e., before the asset 302 is scanned at the gate 341, it is at best unknown whether the asset 302 is being carried by the asset carrier 301 such that the path determined in accordance with the disclosed embodiments would be the portion of the path 321 between the gate 341 and the point B 312).

In a further example instance, the asset carrier 301 proceeds to pick up a second asset 303 at point B 312 and moves to the point C 313. During this movement, the asset carrier 301 passes through a gate 342 and then drops off the second asset 303 at the point C 313. In this regard, during this second portion of this instance in which the asset is moved from point B 312 to point C 313, point B 312 acts as a starting point location of a starting point event in the form of a pickup event, and the location of the gate 342 acts as an ending point location of an ending point event in the form of a scan at the gate 342 such that a path determined for this portion of the instance is a portion of the path 322 between the point B 312 and the location of the gate 342.

In an example implementation, the point B 312 may be within a line of sight of a camera 340 deployed in the environment 330. In this implementation, starting point events which occur at point B 312 may be detected based on visual content such as video and images captured by the camera 340.

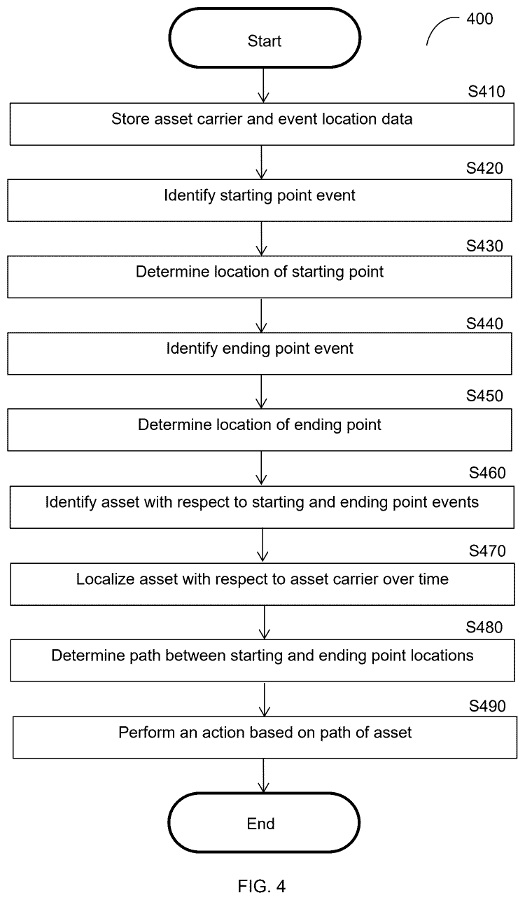

Further in this implementation, when the asset 303 is picked up at point B 312, the pickup of the asset 303 (e.g., as discussed above with respect to the second portion of the instance) is detected as a pickup event based on visual content captured by the camera 340. In this regard, the pickup event occurring at the point B 312 may act as a flow trigger for executing one or more of the processes discussed further below (e.g., the process of FIG. 4). When such a flow trigger is detected, the pickup event is identified as a starting point event and the point B 312 is identified as the starting point location.

Likewise, when the asset 303 is picked up at point B 312, the pickup of the asset 303 (e.g., as discussed above with respect to the first portion of the instance) is detected as a drop off event based on visual content captured by the camera 340. In this regard, the drop off event occurring at the point B 312 may act as a flow trigger for executing one or more of the processes discussed further below (e.g., the process of FIG. 4). When such a flow trigger is detected, the drop off event is identified as a starting point event and the point B 312 is identified as the starting point location.

In an alternative implementation, starting point events which occur at point B 312 may be detected based on increase or decrease in weight applied to a weight sensor of the asset carrier 301.

It should be noted that FIG. 3 depicts an instance including two segments (i.e., each segment beginning with a respective starting point event and ending with a respective ending point event) for example purposes, but that various disclosed embodiments are not necessarily limited as such. Movement may be tracked with respect to a single segment or with respect to more than two segments in at least some embodiments.

FIG. 4 is a flowchart 400 illustrating a method for automatic asset tracking according to an embodiment. In an embodiment, the method is performed by the tracking manager 130, FIG. 1.

At optional S410, asset carrier and event location data are stored. The data may be stored in one or more databases such as, but not limited to, the databases 160, FIG. 1.

The asset carrier data may be received from one or more asset carriers, or collected from asset carriers (e.g., by a mapping service such as the mapping service 170, FIG. 1). In an embodiment, the asset carrier data includes locations of the asset carrier at various times. To this end, in a further embodiment, the asset carrier data also includes timestamps for corresponding location points. The asset carrier data may be utilized to determine locations of assets carried by asset carriers between starting and ending point locations as discussed herein.

In some implementations, the asset carrier data may be recorded by the asset carrier as the asset carrier moves. To this end, the asset carrier data may be determined based on global positioning system (GPS) coordinates obtained by the asset carrier, based on odometry readings from wheels of the asset carrier, or otherwise based on data which can be utilized to determine how far and in which directions the asset carrier moves.

In yet a further embodiment, the asset carrier data further includes positional data about one or more components of the asset carrier. As a non-limiting example, such positional data may include positions of forks relative to a forklift. As discussed herein, the positional data may be utilized to more granularly determine positions of assets carried by asset carriers (e.g., by calculating a position in three-dimensional space of an asset carried by a forklift based on a location of the forklift and a position of forks of the forklift). The positional data may include specific coordinates in 3D space of the components, or may indicate a status of the component (e.g., a status may be either forks raised or forks lowered).

The event location data may include data collected when potential starting point and ending point events are detected. The event location data may indicate a location of the asset or of the asset carrier which carries the asset (thereby also identifying the location of the asset) at points in time when potential starting or ending point events occurred.

In some embodiments, S410 may be performed at a remote time from the other steps, or may be performed by a different system than the system performing the method of FIG. 4. As noted above, the disclosed embodiments may be utilized to accurately determine specific locations of assets without requiring storing or using as much location data compared to at least some existing solutions. Thus, the method of FIG. 4 may be utilized to enable reconstructing locations of assets after the fact.

At S420, a first starting point event is identified. More specifically, the starting point event is an event in which an asset carrier such as a vehicle interacts with an asset such as an object. The starting point event acts as a trigger for the flow of FIG. 4. More specifically, the starting point event is a first event which triggers identifying a second event as an ending point event in order to determine a path of the asset between the starting and ending point events.

Non-limiting example starting point events include, but are not limited to, a pickup event or a drop off event. A pickup event may occur, for example, when the asset is picked up by or placed on the asset carrier (as a non-limiting example, when the asset is picked up by forks of a forklift). A drop off event may occur, for example, when the asset is dropped off or otherwise removed from the asset carrier.

In an embodiment, the starting point event is detected based on sensor signals of the asset carrier. In a further embodiment, such sensor signals include sensor signals of a weight sensor used to detect a weight being placed on the asset carrier or a component of the asset carrier by an object. In yet a further embodiment, an increase in weight above a threshold result in detecting a pickup event, and a decrease in weight above a threshold may result in detecting a drop off event.

In an embodiment, identifying the starting point event further includes identifying the asset involved in the starting point event. In a further embodiment, the asset is identified for the starting point event by scanning the asset (e.g., by an operator of the asset carrier).

At S430, a first starting point location of the starting point event is determined. The starting point location is a location of the asset at the time of the starting point event and may be determined, for example, based on a known location of the asset carrier at the time of the starting point event.

At S440, a second ending point event is identified. The ending point event may be indicative of one or more predetermined ending point event actions of the asset carrier. To this end, in an embodiment, the ending point event is identified based on movement of the asset carrier with respect to an ending point location. Non-limiting example ending point events may be or may include, but are not limited to, passing a checkpoint or gate (e.g., as detected by scanning a barcode of the asset carrier as it passes through the checkpoint or gate), occupying a certain location, performing an action to release the asset (e.g., lowering forks of a forklift on which the asset is disposed), and the like.

In an embodiment, identifying the ending point event further includes identifying the asset involved in the ending point event. In a further embodiment, the asset is identified for the ending point event by scanning the asset (e.g., at the endpoint or by an operator of the asset carrier).

At S450, a second ending point location of the ending point event is determined. In an embodiment, the ending point location is determined based on a location of an endpoint (e.g., a checkpoint or gate) which the asset carrier passed at during the ending point event. The passing of the asset carrier at the endpoint may be determined, for example, based on scanning of the asset carrier or of the asset, or based on visual content showing passing of the asset carrier at the endpoint. In another embodiment, the ending point location is determined based on a known location of the asset carrier.

It should be noted that the first and second events are described as starting and ending point events for simplicity because the starting point event is a starting point for determining the path and the ending point event acts as a terminator for path determination, but that the starting point event does not necessarily occur before the ending point event temporally. That is, the sequence of events may be different from the sequence of the identification of those events without departing from the scope of the disclosure. As a non-limiting example, the starting point event may be identified as a drop off event where an asset is dropped off by an asset carrier. In such an example, the ending point event is determined based on the asset being scanned at a gateway which is known to be at a location where assets are picked up by asset carriers. Thus, in such an example, the ending point event including picking up the asset may occur at a first time, and the starting point event including dropping off the asset may occur at a later second time. Likewise, the starting point event may occur before the ending point event without departing from the scope of the disclosure.

At S460, an asset is identified with respect to the starting and ending point events. In an embodiment, the identified asset is an asset which was identified with respect to each of the starting point event and the ending point event as discussed above.

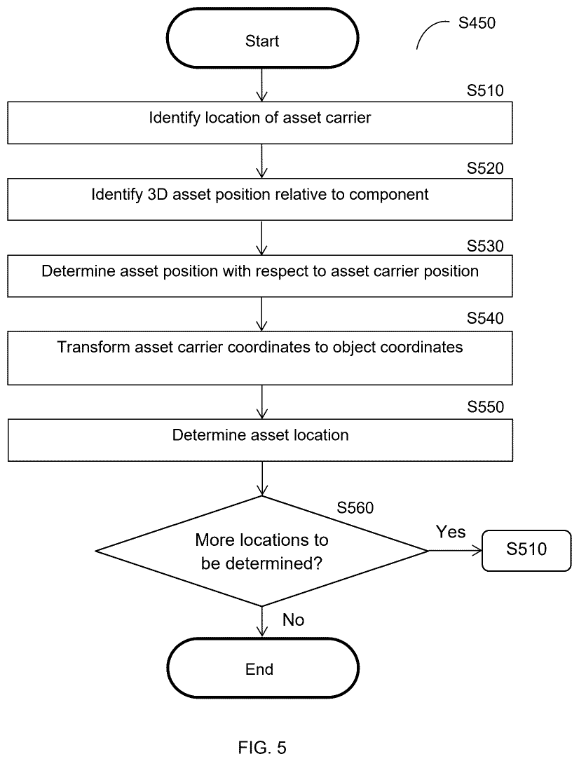

At S470, the asset is localized with respect to an asset carrier over time. In an embodiment, the asset is localized with respect to the asset carrier in order to determine a relative position of the asset with respect to the asset carrier, which in turn may be utilized to determine a position of the asset at each of a set of points of time based on positions of the asset carrier at each of the points of time. More specifically, based on a relationship between the location of the asset and the asset carrier during a given period of time, the position of the asset may be determined for a given point in time during that period of time based on a position of the asset carrier at that point in time. An example process which may be utilized for localizing the asset with respect to the asset carrier over time is discussed further below with respect to FIG. 5.

In at least some embodiments, the path, a specific location of the asset along that path, or both, may be calculated on demand. That is, in such embodiments, the necessary computations for localizing the asset relative to the asset carrier in order to determine a location of the asset at a given point in time may be performed only as needed. By only localizing the asset relative to the asset carrier as needed, the amount of additional data needed to store various locations and positions of the asset, as well as the computational power needed to calculate each of those locations and positions, can be reduced.

At S480, a path of the asset between the starting and ending point locations is determined based on the localization of the asset with respect to the asset carrier as well as locations of the asset carrier over time. In an embodiment, determining the path of the asset includes determining a position of the asset at each time of a set of times. As noted above, in an embodiment, the position of the asset at a given point in time is determined based on a position of the asset carrier which is carrying the asset at that point in time.

Further, the locations of the asset along the path may be associated with respective times. To this end, in an embodiment, determining the path of the asset may further include determining times of respective locations of the asset along the path. Such times may be determined, for example, based on timestamps of location data indicating locations occupied by the asset carrier at the corresponding times.

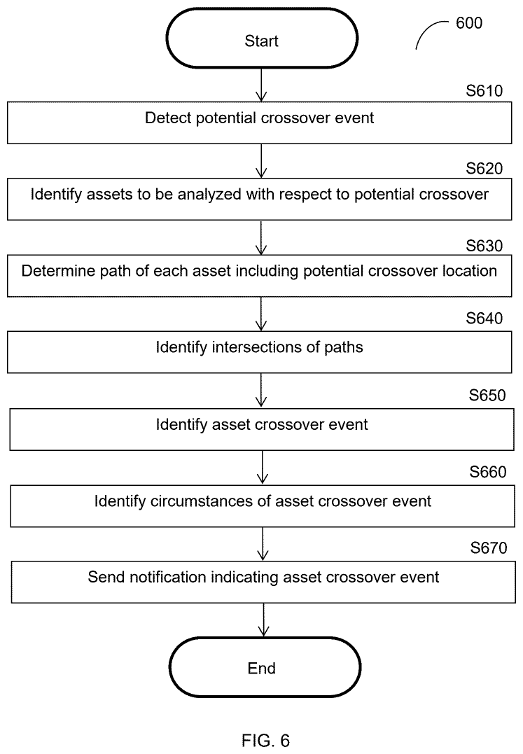

At S490, an action is performed based on the path of the asset. More specifically, the action may be performed based on one or more locations occupied by the asset between the starting point event and the ending point event. In an embodiment, performing the action is or includes determining a location of the asset at one or more points in time based on the path of the asset. The performed action may be or may include, but is not limited to, sending a notification indicating the path of the asset or any points along the path of the asset, detecting a crossover event between the asset and another asset, and the like. An example process for detecting a crossover event is described further below with respect to FIG. 6.

FIG. 5 is a flowchart S470 illustrating a method for analyzing vehicle localization data according to an embodiment.

At S510, a location of an asset carrier is identified. The asset carrier is an asset carrier which is carrying an asset such as, but not limited to, an object. The location of the asset carrier may be a location at a specific point in time, for example, a time between times at which a starting point event and an ending point event occurred. By identifying locations of the asset carrier at different points in time, locations of an asset carried by the asset carrier may be determined for those points in time.

At optional S520, a three-dimensional (3D) asset position may be identified relative to a component of the asset carrier. The 3D asset position is a position of the asset in 3D space at a given point in time. The component of the asset carrier may be a component used to pick up and drop off assets, or otherwise to carry assets. To this end, a non-limiting example of such a component is a set of forks of a forklift acting as the asset carrier.

In an embodiment, S520 includes determining a position in 3D space of the component of the asset carrier which is used to carry the asset. Based on the determined position of the asset carrier component, a position of the asset may be calculated. In some embodiments, the position of the asset relative to the component of the asset carrier is based on a predetermined relationship, and calculating the position of the asset includes applying the predetermined relationship to the position of the component of the asset carrier.

In a further embodiment, the position of the component of the asset carrier may be determined based further on a current status of the component. To this end, different statuses of the component may be associated with respective predetermined positions in 3D space. As a non-limiting example for forks of a forklift, a status of forks raised may be associated with a first predetermined position in 3D space, and a status of forks lowered may be associated with a second predetermined position in 3D space. A 3D asset position relative to the component may be determined based on the first predetermined position when the forks are raised, and based on the second predetermined position when the forks are lowered.

At S530, a position of an asset with respect to a position of the asset carrier is determined. The determined position is a relative position reflecting a relationship in space between the asset and the asset carrier. In an embodiment, the position of the asset with respect to the position of the asset carrier is predetermined. In a further embodiment, the position of the asset with respect to the position of the asset carrier may be associated with the asset carrier or a type of the asset carrier.

The position of the asset with respect to the position of the asset carrier may be defined with respect to differences in coordinates between the position of the asset and the position of the asset carrier when the asset is carried by the asset carrier. The position may further be defined either using differences between two-dimensional coordinates or three-dimensional coordinates between the asset and the asset carrier while the asset is being carried by the asset carrier. Such differences may be used to calculate a position of the asset based on a position of the asset carrier as discussed herein, for example, by summing the position of the asset carrier with the coordinate differences in order to obtain an absolute the position of the asset.

At S540, coordinates of the asset carrier are transformed into coordinates of the asset based on the position of the asset with respect to the position of the asset carrier. As noted above, the coordinates of the asset may be calculated by applying the coordinates of the asset carrier with the coordinate transformation between the position of the asset and the position of the asset carrier.

At S550, a location of the asset at a given point in time is determined based on the transformed coordinates. More specifically, the location of the asset may be determined as the coordinates of the asset calculated during the transformation.

At S560, it is checked whether more asset locations are to be determined and, if so, execution continues with S510; otherwise, execution terminates.

FIG. 6 is a flowchart 600 illustrating a method for identifying asset crossover events utilizing automatic asset tracking according to an embodiment. In an embodiment, the method is performed by the tracking manager 130, FIG. 1.

At optional S610, a potential crossover event is detected. The potential crossover event may be or may include an event to be analyzed for potential crossover between assets. In some implementations, the potential crossover event is detected based on indicators of a crossover such as, but not limited to, cross-contamination between materials, analysis of visual content demonstrating assets of certain types crossing paths, information provided by individuals in an environment where assets are moved, and the like.

At S620, assets to be analyzed with respect to a potential crossover event are identified. The assets may be identified in visual content (e.g., in camera footage), based on scans (e.g., scans of the assets at gateways within a warehouse), both, and the like.

At S630, a path of each asset which includes the location of the potential crossover event is determined. The path of each asset includes a set of locations occupied by the asset beginning with a starting point location and terminating with an ending point location.

In an embodiment, paths of the assets including the location of the potential crossover event are determined based on a time of the potential crossover event and times at which each asset moved through one or more paths, and paths which occurred within temporal proximity to the potential crossover event may be determined. In a further embodiment, such paths may be determined by identifying starting point events, ending point events, or both, for each asset, which occurred within a threshold period of time of the potential crossover event. That is, events which are indicative of movement of the asset (e.g., a starting point event indicating that the asset moved after the starting point event or an ending point event indicating that the asset moved prior to the ending point event) which occurred within a threshold period of time of the potential crossover event may be identified as events of candidate paths for each asset, and the candidate path for each identified event may be determined. Candidate paths which include the location of the potential crossover event may be used as the determined paths for S630.

By selecting candidate paths based on temporal proximity, crossover events may be identified more granularly with respect to time in addition to physical location. In this regard, it is noted that two assets moving along overlapping paths may not represent a true crossover event in at least some circumstances. That is, in some implementations, a crossover event may only occur when the paths of different assets cross and the assets moved along their respective paths within a threshold period of time from each other. For example, when the crossover event is identified in order to identify instances of cross-contamination, paths which cross but were traversed by their respective assets weeks or months apart may not be determined as representing a crossover event because any such movement through the same location would not have resulted in actual cross-contamination due to the time difference between when the assets moved through this location.

In an embodiment, one or more paths of each asset are determined as discussed further above with respect to FIG. 4. For example, for each event of a candidate path identified as occurring within a threshold period of time of the potential crossover event, the respective candidate path may be determined using the process described with respect to FIG. 4. The identified path for each asset may be selected from among the paths determined for the asset in this manner. As noted above, the techniques described herein may be utilized to reconstruct paths traversed by assets, which in turn may be utilized to more efficiently retroactively determine the paths traversed by those assets without requiring tracking locations of each asset at all times. Accordingly, such path determination may be leveraged to more efficiently determine paths to be used for identifying crossover events.

At S640, one or more intersections between the paths are identified. Each intersection may be or may include a common point shared between paths. That is, each intersection is a location occupied by each asset in their respective paths. Accordingly, each intersection represents a crossover between the assets.

At S650, an asset crossover event is identified based on the identified intersections. In an embodiment, the asset crossover event is an event including the movement of each asset through the intersection within a threshold period of time from each other. That is, the asset crossover event is an event where two assets occupy the same location within a certain time period from each other.

The crossover event may represent an event which might have resulted in cross-contamination or which otherwise might be used to identify how interactions between the assets may have occurred.

At optional S660, circumstances of the asset crossover event may be determined. The circumstances of the asset crossover event may be or may include, but are not limited to, one or more times of the asset crossover (e.g., times at which the intersections identified at S640 occurred), one or more locations of the asset crossover (e.g., locations at which the intersections identified at S640 occurred), both, and the like.

At optional S670, a notification indicating the asset crossover event may be sent, for example, to a user device (e.g., the user device 120, FIG. 1). The notification may indicate, but is not limited to, time of the crossover event, location of the crossover event, the assets involved in the crossover event, a combination thereof, and the like.

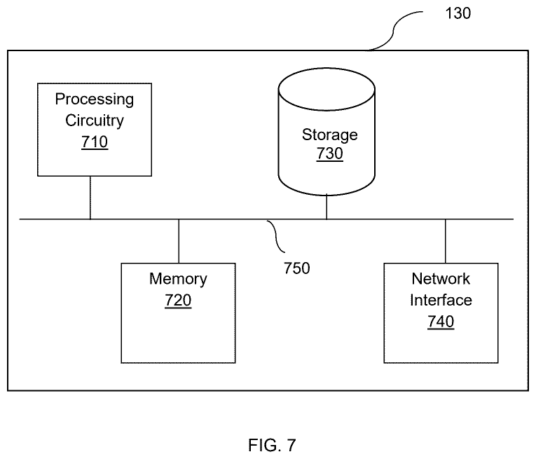

FIG. 7 is an example schematic diagram of a tracking manager 130 according to an embodiment. The tracking manager 130 includes a processing circuitry 710 coupled to a memory 720, a storage 730, and a network interface 740. In an embodiment, the components of the tracking manager 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the tracking manager 130 to communicate with other systems, devices, components, applications, or other hardware or software components, for example as described herein.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for asset tracking, comprising:
identifying a first event, wherein the first event occurs when an asset carrier interacts with an asset at a first location;
identifying a second event, wherein the second event is detected based on an activity of the asset carrier with respect to a second location;
identifying the asset with respect to each of the first event and the second event;
determining a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and
determining a location of the asset at a first time of the plurality of times based on the path.

2. The method of claim 1, further comprising:
performing an action with respect to the asset based on the determined location.

3. The method of claim 1, wherein determining the path of the asset further comprises:
determining a position of the asset with respect to the asset carrier for the plurality of times, wherein the plurality of locations of the asset are determined based on the plurality of locations occupied by the asset carrier and the position of the asset with respect to the asset carrier.

4. The method of claim 3, further comprising:
determining a position of the asset with respect to a component of the asset carrier, wherein the position of the asset with respect to the asset carrier is determined based further on the position of the asset with respect to the component.

5. The method of claim 1, wherein the second event is identified based on visual content showing the asset carrier interacting with the asset.

6. The method of claim 5, wherein the visual content is captured by a camera at a camera location, further comprising:
determining the first location based on the camera location and the visual content showing the asset carrier interacting with the asset.

7. The method of claim 1, wherein the second event is detected when at least a portion of the asset carrier is scanned at the second location.

8. The method of claim 1, wherein the first event is a pickup of the asset.

9. The method of claim 1, wherein the first event is a drop off of the asset.

10. A non-transitory computer readable medium having stored thereon instructions for causing a processing circuitry to execute a process, the process comprising:
identifying a first event, wherein the first event occurs when an asset carrier interacts with an asset at a first location;
identifying a second event, wherein the second event is detected based on an activity of the asset carrier with respect to a second location;
identifying the asset with respect to each of the first event and the second event;
determining a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and
determining a location of the asset at a first time of the plurality of times based on the path.

11. A system for asset tracking, comprising:
a processing circuitry; and
a memory, the memory containing instructions that, when executed by the processing circuitry, configure the system to:
identify a first event, wherein the first event occurs when an asset carrier interacts with an asset at a first location;
identify a second event, wherein the second event is detected based on an activity of the asset carrier with respect to a second location;
identify the asset with respect to each of the first event and the second event;
determine a path of the asset between the first location and the second location based on a plurality of locations occupied by the asset carrier between the first event and the second event, wherein the path includes a plurality of locations of the asset at a plurality of times, wherein the plurality of locations occupied by the asset carrier between the first event and the second event correspond to respective times of the plurality of times; and
determine a location of the asset at a first time of the plurality of times based on the path.

12. The system of claim 11, wherein the system is further configured to:
perform an action with respect to the asset based on the determined location.

13. The system of claim 11, wherein the system is further configured to:
determine a position of the asset with respect to the asset carrier for the plurality of times, wherein the plurality of locations of the asset are determined based on the plurality of locations occupied by the asset carrier and the position of the asset with respect to the asset carrier.

14. The system of claim 13, wherein the system is further configured to:
determine a position of the asset with respect to a component of the asset carrier, wherein the position of the asset with respect to the asset carrier is determined based further on the position of the asset with respect to the component.

15. The system of claim 11, wherein the second event is identified based on visual content showing the asset carrier interacting with the asset.

16. The system of claim 15, wherein the visual content is captured by a camera at a camera location, wherein the system is further configured to:
determine the first location based on the camera location and the visual content showing the asset carrier interacting with the asset.

17. The system of claim 11, wherein the second event is detected when at least a portion of the asset carrier is scanned at the second location.

18. The system of claim 11, wherein the first event is a pickup of the asset.

19. The system of claim 11, wherein the first event is a drop off of the asset.
